(19) United States
(12) Patent Application Publication
(10) Pub. No.: US 2026/0312176 A1
(43) Pub. Date: Oct. 8, 2026

(54) BATTERY ARRAY DESIGNS FOR TRACTION BATTERY PACKS

(71) Applicant: FORD GLOBAL TECHNOLOGIES, LLC, Dearborn, MI (US)

(72) Inventors: Jie Deng, Novi, MI (US); Nan Robarge, Saline, MI (US); Xiaogang Zhang, Novi, MI (US); Adam Denlinger, Saline, MI (US)

(21) Appl. No.: 19/171,547

(22) Filed: Apr. 7, 2025

(51) Int. Cl. H01M 10/6556; H01M 10/613; H01M 10/625; H01M 50/211; H01M 50/242; H01M 50/249; H01M 50/271; H01M 50/289; H01M 50/367

(52) U.S. Cl. CPC H01M 10/6556; H01M 10/613; H01M 10/625; H01M 50/211; H01M 50/242; H01M 50/249; H01M 50/271; H01M 50/289; H01M 50/367; H01M 2220/20

(57) ABSTRACT

Battery array designs are provided for use within a traction battery pack. An exemplary battery array may include an array housing having a ribbed structure that includes at least one rib configured for increasing the structural stiffness of the battery array. The rib may extend within a defined space that is located axially between a first battery cell separator and a second battery cell separator of a cell stack of the battery array. Placement of the rib at this location can provide numerous benefits, including but not limited to, increasing cooling efficiency during normal battery operating conditions and mitigating the transfer of thermal energy across the cell stack by reducing the speed of vent gases during battery thermal events.

### TECHNICAL FIELD

This disclosure relates generally to electrified vehicle traction battery packs, and more particularly to battery array designs for delaying the transfer of thermal energy within traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, an array housing, and a cell stack housed inside the array housing and including a first battery cell separator, a second battery cell separator, and a cell packet arranged between the first battery cell separator and the second battery cell separator. A first rib of the array housing is located axially between the first battery cell separator and the second battery cell separator.

In a further non-limiting embodiment of the foregoing battery array, the first rib is part of a top cover of the array housing.

In a further non-limiting embodiment of either of the foregoing battery arrays, the first rib is part of a bottom cover of the array housing.

In a further non-limiting embodiment of any of the foregoing battery arrays, a second rib of the array housing is located axially between the first battery cell separator and the second battery cell separator.

In a further non-limiting embodiment of any of the foregoing battery arrays, the first battery cell separator separates a first compartment where the cell packet resides from a second compartment where a second cell packet resides.

In a further non-limiting embodiment of any of the foregoing battery arrays, the first compartment and the second compartment establish separate coolant flow passages inside the battery array.

In a further non-limiting embodiment of any of the foregoing battery arrays, the cell packet includes a first battery cell, a second battery cell, and a cell expansion pad between the first battery cell and the second battery cell.

In a further non-limiting embodiment of any of the foregoing battery arrays, the first rib is centered relative to a first centerline axis of the first battery cell.

In a further non-limiting embodiment of any of the foregoing battery arrays, a second rib of the array housing is centered relative to a second centerline axis of the second battery cell.

In a further non-limiting embodiment of any of the foregoing battery arrays, the cell expansion pad is located axially between the first rib and the second rib.

In a further non-limiting embodiment of any of the foregoing battery arrays, an upper portion or a lower portion of each of the first battery cell separator and the second battery cell separator extends above or below the cell packet to establish a first compartment that is configured to receive a coolant of a thermal management system.

In a further non-limiting embodiment of any of the foregoing battery arrays, the cell stack includes a second cell packet arranged between the second battery cell separator and a third battery cell separator.

In a further non-limiting embodiment of any of the foregoing battery arrays, a second rib of the array housing is located axially between the second battery cell separator and the third battery cell separator.

A battery array for a traction battery pack according to another exemplary aspect of the present disclosure includes, among other things, a cell stack including a first battery cell separator, a second battery cell separator, and a cell packet arranged between the first battery cell separator and the second battery cell separator. An array housing encloses the cell stack. A compartment extends between the array housing and the cell packet and further between the first battery cell separator and the second battery cell separator. A first rib of the array housing extends into the compartment.

In a further non-limiting embodiment of the foregoing battery array, the first rib protrudes from a top cover of the array housing in a direction toward the cell packet.

In a further non-limiting embodiment of either of the foregoing battery arrays, the first rib protrudes from a bottom cover of the array housing in a direction toward the cell packet.

In a further non-limiting embodiment any of the foregoing battery arrays, the first rib is located axially between the first battery cell separator and the second battery cell separator.

In a further non-limiting embodiment any of the foregoing battery arrays, a second rib of the array housing is located axially between the first battery cell separator and the second battery cell separator.

In a further non-limiting embodiment any of the foregoing battery arrays, the first rib is centered relative to a first centerline axis of a first battery cell of the cell packet, and the second rib is centered relative to a second centerline axis of a second battery cell of the cell packet.

In a further non-limiting embodiment any of the foregoing battery arrays, a cell expansion pad of the cell packet is sandwiched between the first battery cell and the second battery cell.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of an exemplary battery array of a traction battery pack.

FIG. 3 is an exploded view of the battery array of FIG. 2.

FIG. 4 is a cross-sectional view through section 4-4 of FIG. 2.

FIG. 5 is a blown-up view of a select portion of the battery array of FIG. 4.

FIG. 6 is a blown-up view of another portion of the battery array of FIG. 4.

FIG. 7 illustrates select portions of another exemplary battery array.

### DETAILED DESCRIPTION

This disclosure details battery array designs for use within a traction battery pack. An exemplary battery array may include an array housing having a ribbed structure that includes at least one rib configured for increasing the structural stiffness of the battery array. The rib may extend within a defined space that is located axially between a first battery cell separator and a second battery cell separator of a cell stack of the battery array. Placement of the rib at this location can provide numerous benefits, including but not limited to, increasing cooling efficiency during normal battery operating conditions and mitigating the transfer of thermal energy across the cell stack by reducing the speed of vent gases during battery thermal events. These and other features are discussed in greater detail in the following paragraphs of this detailed description.

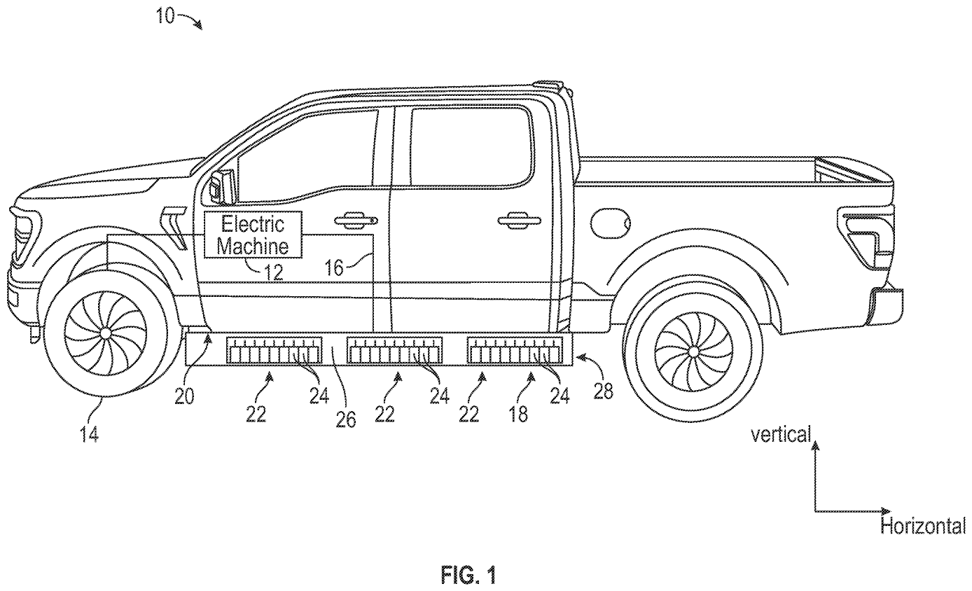

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules, assemblies, or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28 of the traction battery pack 18. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

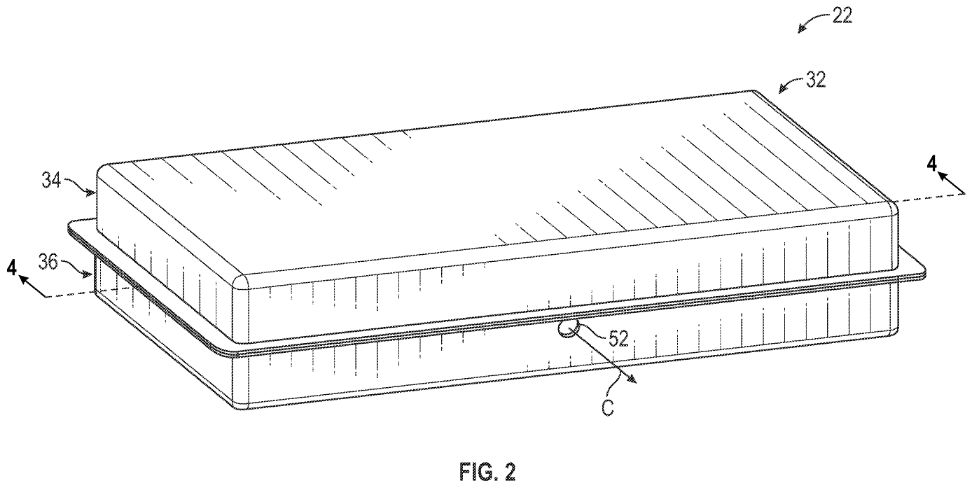

FIGS. 2-6 illustrate features associated with a battery array 22 of a traction battery pack. For example, the traction battery pack 18 of the electrified vehicle 10 of FIG. 1 could include one or more battery arrays having a design substantially similar to that of the battery array 22 shown in FIGS. 2-6.

The battery array 22 may include one or more cell stacks 30 housed within an array housing 32. The array housing 32 may include a top cover 34 and a bottom cover 36, which may both be tray-like structures. The top cover 34 may be positioned vertically above the bottom cover 36. Various terms such as “above,” “below,” “top,” and “bottom” are used relative to the arrangement of the components of the traction battery pack 18 in the various drawings and should not otherwise be deemed limiting. These terms are with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

The top cover 34 may be secured (e.g., bolted, welded, adhered, etc.) to the bottom cover 36 to provide a sealed enclosure for housing the cell stack 30. The size, shape, and configuration of the array housing 32 could vary within the scope of this disclosure.

The cell stack 30 may include a plurality of individual battery cells 24 arranged longitudinally between opposing end plates 38. The battery cells 24 may be arranged together along a cell stack axis A between the opposing end plates 38. Although a single cell stack 30 having a specific number of battery cells 24 is illustrated in the figures of this disclosure, the battery array 22 could include any number of cell stacks 30, with each cell stack 30 having any number of individual battery cells 24.

Thermal energy levels of the battery cells 24 of the battery array 22 can increase as the electrified vehicle 10 is operated. A thermal management system can be employed for managing the thermal energy levels of the battery cells 24 of the battery array 22. The thermal management system may be configured to route a coolant C through the battery array 22 in order to manage the thermal energy levels of battery array 22 by, for example, using the coolant C to take on and carry away thermal energy from the battery cells 24 of the cell stack 30.

In an embodiment, the thermal management system is an immersion thermal management system in which portions of the cell stack 30, here at least portions of the battery cells 24, for example, can be immersed in the coolant C. Thermal energy can transfer between the coolant C and the battery cells 24 as the coolant C flows over and/or around the battery cells 24 inside the array housing 32. The coolant C can help manage thermal energy levels of the battery cells 24 as well as other components of the battery array 22.

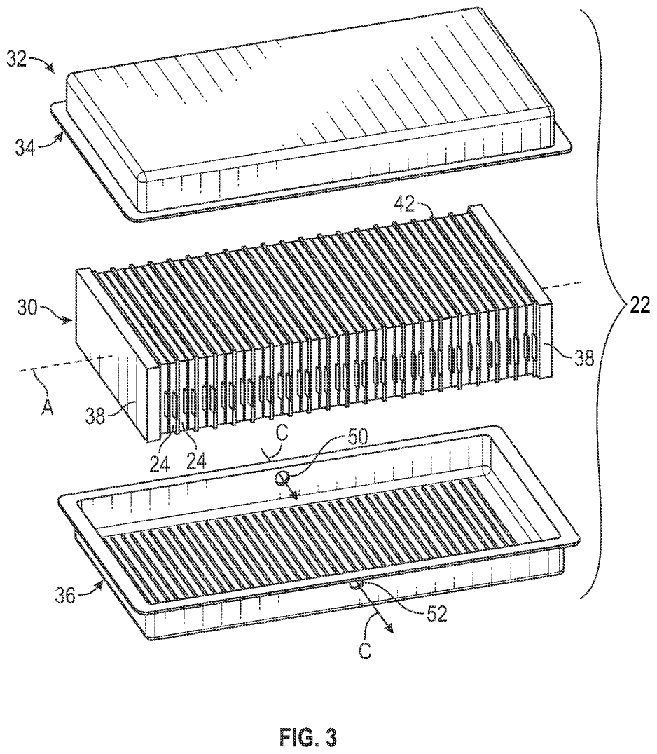

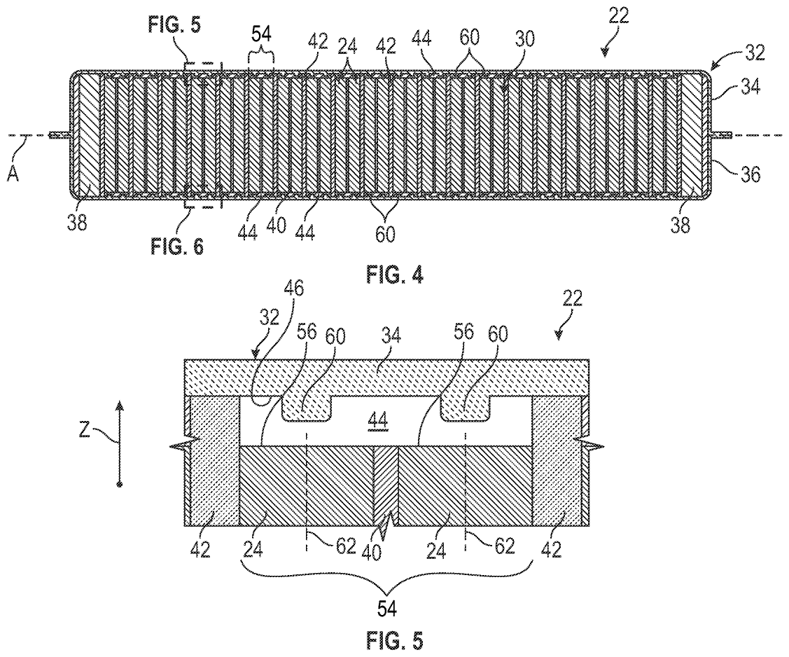

The thermal management system can deliver the coolant C to the interior of the battery array 22 through an inlet 50 (see FIG. 3) of the array housing 32. The coolant C can fill one or more open areas (see, e.g., compartments 44 identified in FIGS. 4-6) inside the battery array 22 such that the battery cells 24 are directly contacted by the coolant C. The coolant C can take on thermal energy from the battery cells 24 for managing the thermal energy levels of the battery array 22. The coolant C may exit the battery array 22 through an outlet 52 (see FIGS. 2-3) of the array housing 32. In an embodiment, both the inlet 50 and the outlet 52 are formed through the bottom cover 36 of the array housing 32. However, other inlet 50 and/or outlet 52 locations are contemplated within the scope of this disclosure.

The coolant C exiting through the outlet 52 can move to a thermal energy exchange device (not shown), such as a heat exchanger, for example, where thermal energy can be transferred from the coolant C to atmosphere. A pump (not shown) can be operated to selectively circulate the coolant C between the battery array 22 and the thermal energy exchange device and then back to the battery array 22 as part of a closed-loop system.

The coolant C circulated in the immersion thermal management system may be a dielectric fluid or another type of non-electrically conductive fluid (e.g., oil) that is designed for immersion cooling the battery cells 24. However, other non-conductive fluids may also be suitable, and the actual chemical make-up and design characteristics (e.g., dielectric constant, maximum breakdown strength, boiling point, thermal conductivity, etc.) may vary depending on the environment the battery array 22 is to be deployed.

In another embodiment, the thermal management system is a conventional cold plate system in which the coolant C, such as ethylene glycol, is circulated through a cold plate (not shown) in order to thermally manage heat generated by the battery cells 24. The teachings of this disclosure are therefore not limited to battery arrays having immersion thermal management systems. The battery cells 24 are not immersed in the coolant C in the cold plate type of thermal management system.

Referring now primarily to FIGS. 4-6, with continued reference to FIGS. 2-3, a cell expansion pad 40 may be arranged between neighboring battery cells 24 within the cell stack 30. The cell expansion pads 40 may include a material(s) (e.g., polyurethane foam, silicone foam, etc.) adapted for accommodating battery cell swelling.

A plurality of battery cell separators 42 may also be arranged along the cell stack axis A of the cell stack 30. The battery cell separators 42 may be arranged to compartmentalize the cell stack 30 into a plurality of compartments 44. Each compartment 44 may establish a dedicated coolant flow passage for directing the coolant C through the battery array 22 as part of the immersion thermal management system described above. The battery cell separators 42 are multi-functional components that can support the plurality of battery cells 24 of the cell stack 30 and carry their weight and load during shock and vibration, reduce heat transfer across the cell stack 30, dissipate heat from the battery cells 24 into the array housing 32, etc.

Each compartment 44 may house a cell packet 54, which is a subgrouping of the plurality of battery cells 24 of the cell stack 30. In an embodiment, each cell packet 54 includes two battery cells 24 and one cell expansion pad 40 that is sandwiched between the two battery cells 24. The cell packets 54 are therefore disposed between adjacent pairs of the battery cell separators 42 and are separated from other cell packets 54 by the battery cell separators 42 that are provided along the cell stack axis A of the cell stack 30. However, other configurations are contemplated within the scope of this disclosure, and it should be evident to those having the benefit of this disclosure that the cell stack 30 could include any number of and any arrangement of battery cells 24, cell expansion pads 40, battery cell separators 42, and cell packets 54.

The battery cell separators 42 may interface with the battery cells 24 and the array housing 32 in order to establish the compartments 44. For example, the battery cell separators 42 may extend above and/or below the battery cells 24 within the cell stack 30 and may be positioned in abutting contact with an inner wall 46 of the top cover 34 and/or an inner wall 48 of the bottom cover 36 of the array housing 32 in order to establish the compartments 44. The compartments 44 may therefore extend vertically between either the inner wall 46 of the top cover 34 or the inner wall 48 of the bottom cover 36 and top surfaces 56/bottom surfaces 58 of the battery cells 24 and horizontally between the portions of the battery cell separators 42 that extend above or below the battery cells 24 within the interior of the array housing 32.

The battery cell separators 42 could include various designs/configurations within the scope of this disclosure. In an embodiment, each battery cell separator 42 may include a fin that is flanked by additional layers, such as foam and/or thermal resistance material layers, for example, as part of a multi-layered structure. In another embodiment, the battery cell separators 42 may each include a fin that is sandwiched between a pair of thermal resistance material layers, and a pair of foam layers may be positioned outboard of the thermal resistance material layers. The foam layers thus flank the thermal resistance material layers and can be positioned in abutting contact with major side surfaces of battery cells 24 located in adjacent compartments 44 of the cell stack 30. The battery cell separators 42 may therefore include metallic materials, high temperature resistance thermoplastic or thermoset composites, aerogel materials, mica materials, foam materials, or any combination of these and/or other materials.

The array housing 32 may be ribbed for increasing its structural stiffness. For example, the top cover 34, the bottom cover 36, or both may include a plurality of ribs 60 for increasing the thickness and therefore the structural stiffness of the array housing 32.

The ribs 60 may protrude from the inner wall 46 of the top cover 34 and/or from the inner wall 48 of the bottom cover 36 in a direction toward the cell stack 30. The ribs 60 may be positioned such that they are spaced apart and located axially between adjacent pairs of the battery cell separators 42 of the cell stack 30. The ribs 60 are therefore located within each compartment 44 of the cell stack 30. At these locations, the ribs 60 may function to increase the cooling efficiency provided by the thermal management system during normal operating conditions of the traction battery pack 18. For example, the ribs 60 can increase the contact area between the coolant C and the array housing 32, reduce the cross-sectional area of each compartment 44 and thereby increase the coolant flow rate around the battery cells 24, and increase turbulence of the coolant C as it flows through the compartments 44.

The ribs 60 may further function to help mitigate the transfer of thermal energy across the battery array 22 during battery thermal events of the traction battery pack 18. For example, the ribs 60 can reduce the speed of venting gases as they move across the cell stack 30 and thereby slow convection, increase the contact area between the venting gases and the array housing 32, and reduce clogging caused by debris or other battery vent byproducts within neighboring coolant flow passages that are established by the compartments 44.

In an embodiment, one rib 60 is included for each battery cell 24 of each cell packet 54 of the cell stack 30. Accordingly, in the exemplary implementation shown in FIGS. 4-6, two ribs 60 are provided within each compartment 44. However, each compartment 44 could include one or more ribs 60 within the scope of this disclosure.

In an embodiment, each rib 60 is axially aligned and thus centered relative to a centerline axis 62 of one of the battery cells 24 of the cell packet 54. In such a configuration, the cell expansion pads 40 may be positioned axially between adjacently located ribs 60 of each compartment 44.

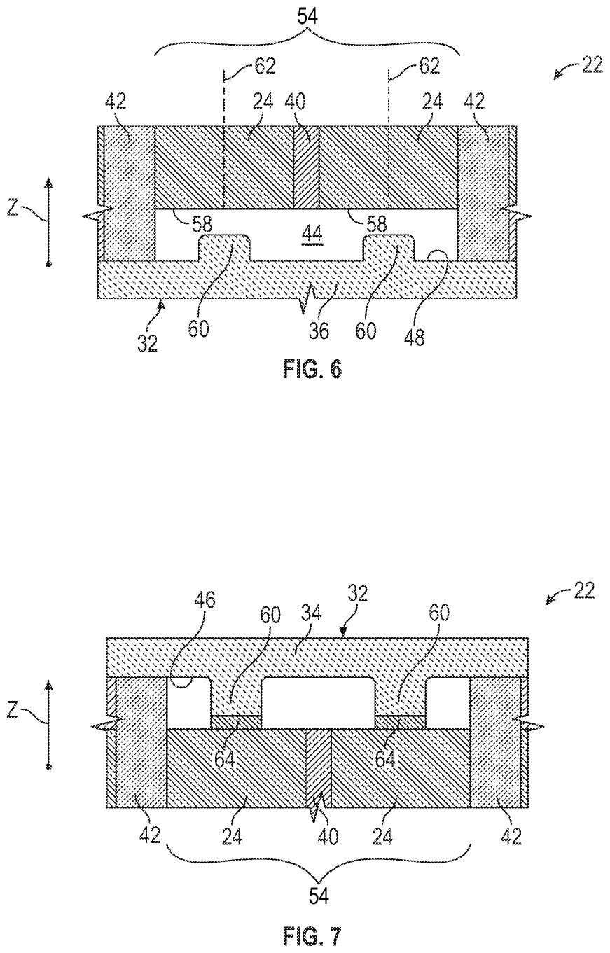

In an embodiment, the ribs 60 extend toward the battery cells 24 of the cell packets 54 but terminate prior to contacting the top surfaces 56 or the bottom surfaces 58 of the battery cells 24 (see, for example, FIGS. 5-6). A gap or open space may therefore extend between the ribs 60 and the battery cells 24.

In another embodiment, an interfacing material 64 may be positioned to extend between each rib 60 of the array housing 32 and the battery cells 24 of the cell stack 30 (see, for example, FIG. 7). The ribs 60 and the interfacing materials 64 may cooperate to increase battery cell retention along the vertical or Z-axis direction of the battery array 22. The ribs 60 and interfacing materials 64 may further subdivide the compartments 44 into multiple coolant flow passages and can slow convective heat transfer during battery thermal events.

In an embodiment, the interfacing materials 64 are configured as foam pads. However, the interfacing materials 64 could employ other materials and/or design configurations within the scope of this disclosure.

The total number, location, size, shape (e.g., cross-sectional area), and arrangement of the ribs 60 could vary and can depend on factors such as the structural stiffness requirements of the battery array 22, clearance distances between the array housing 32 and the battery cells 24 of the cell stack 30, structural and thermal performance requirements of the battery array 22, assembly and manufacturing feasibility of the battery array 22, etc. This disclosure is therefore not intended to be limited to the specific designs shown in the various figures, and it should be appreciated that slight modifications in relation to the ribs 60 could fall within the scope of this disclosure.

The exemplary battery arrays of this disclosure include a combination of battery cell separators and array housings ribs that facilitate the use of immersion cooling for thermally managing the battery array. The proposed designs provide increased structural stiffness and integrity, heat transfer and packaging efficiencies, and cell retention capabilities.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A battery array for a battery pack, comprising:
an array housing; and
a first battery cell separator and a second battery cell separator housed inside the array housing,
wherein a first rib of the array housing is located axially between the first battery cell separator and the second battery cell separator.

2. The battery array as recited in claim 1, wherein the first rib is part of a top cover of the array housing.

3. The battery array as recited in claim 1, wherein the first rib is part of a bottom cover of the array housing.

4. The battery array as recited in claim 1, wherein a second rib of the array housing is located axially between the first battery cell separator and the second battery cell separator.

5. The battery array as recited in claim 1, wherein the first battery cell separator separates a first compartment where a cell packet resides from a second compartment where a second cell packet resides.

6. The battery array as recited in claim 5, wherein the first compartment and the second compartment establish separate coolant flow passages inside the battery array.

7. The battery array as recited in claim 5, wherein the cell packet includes a first battery cell, a second battery cell, and a cell expansion pad between the first battery cell and the second battery cell.

8. The battery array as recited in claim 7, wherein the first rib is centered relative to a first centerline axis of the first battery cell.

9. The battery array as recited in claim 7, wherein a second rib of the array housing is centered relative to a second centerline axis of the second battery cell.

10. The battery array as recited in claim 9, wherein the cell expansion pad is located axially between the first rib and the second rib.

11. The battery array as recited in claim 1, wherein an upper portion or a lower portion of each of the first battery cell separator and the second battery cell separator extends above or below a cell packet to establish a first compartment that is configured to receive a coolant of a thermal management system.

12. The battery array as recited in claim 5, wherein a second cell packet is arranged between the second battery cell separator and a third battery cell separator.

13. The battery array as recited in claim 12, wherein a second rib of the array housing is located axially between the second battery cell separator and the third battery cell separator.

14. A battery array for a battery pack, comprising:
a cell stack including a first battery cell separator, a second battery cell separator, and a cell packet arranged between the first battery cell separator and the second battery cell separator;
an array housing that encloses the cell stack;
a compartment extending between the array housing and the cell packet and further between the first battery cell separator and the second battery cell separator; and
a first rib of the array housing extending into the compartment.

15. The battery array as recited in claim 14, wherein the first rib protrudes from a top cover of the array housing in a direction toward the cell packet.

16. The battery array as recited in claim 14, wherein the first rib protrudes from a bottom cover of the array housing in a direction toward the cell packet.

17. The battery array as recited in claim 14, wherein the first rib is located axially between the first battery cell separator and the second battery cell separator.

18. The battery array as recited in claim 17, wherein a second rib of the array housing is located axially between the first battery cell separator and the second battery cell separator.

19. The battery array as recited in claim 18, wherein the first rib is centered relative to a first centerline axis of a first battery cell of the cell packet, and the second rib is centered relative to a second centerline axis of a second battery cell of the cell packet.

20. The battery array as recited in claim 19, wherein a cell expansion pad of the cell packet is sandwiched between the first battery cell and the second battery cell.
